(19) United States
(12) Patent Application Publication
(10) Pub. No.: US 2025/0058538 A1
(43) Pub. Date: Feb. 20, 2025

(54) LIQUID POLYMER APPLICATION TO SPORTING GOODS PRODUCTS

(71) Applicant: adidas AG, Herzogenaurach (DE)

(72) Inventors: Marco Florian KORMANN, Fuerth (DE); Christoph DYCKMANS, Fuerth (DE); Tru LE, Herzogenaurach (DE); David O’MAHONY, Nuremberg (DE); Thomas HENWOOD, Nuremberg (DE); Yu-Chia LIN, New Taipei City (TW); Tsung-Han LEE, New Taipei City (TW); Chien-An KE, New Taipei City (TW); Li-Wei CHEN, Taitung County (TW)

(21) Appl. No.: 18/806,358

(22) Filed: Aug. 15, 2024

(30) Foreign Application Priority Data
Aug. 16, 2023 (DE) 10 2023 207 871.6

(51) Int. Cl. B29D 35/12; A43B 13/04; B29D 35/00; B29D 35/14

(52) U.S. Cl. CPC B29D 35/122; A43B 13/04; B29D 35/0009; B29D 35/142; B29D 35/148

(57) ABSTRACT

The present disclosure relates to a method for producing a component, preferably for a sporting good, comprising the following steps: providing a polymer; providing a solvent; mixing the polymer with the solvent, thereby producing a liquefied polymer; and curing the liquefied polymer, thereby producing the component. Other embodiments of the disclosure relate to an outsole and a sports shoe obtained by the method according to the disclosure.

### CROSS REFERENCE TO RELATED APPLICATIONS

This application claims priority to German Patent Application No. 10 2023 207 871.6, filed Aug. 16, 2023, which is incorporated by reference herein in its entirety.

### TECHNICAL FIELD

The present disclosure relates to methods for producing a component, such as for a sporting good, an outsole manufactured with such a method as well as methods for producing a sports shoe with such an outsole and the sports shoe.

### BACKGROUND

Manufacturing sporting goods, such sports shoes, includes multiple steps and processes. For example, in case of a sports shoe, the first step is designing the outsole, which includes determining its shape, dimensions, tread pattern, and other features. This includes the choice of materials used in the production. Nowadays, outsoles are typically made from various types of rubber or synthetic compounds. The material choice depends on factors such as the desired level of traction, durability, flexibility, weight and specific performance requirements.

Outsoles, but other sporting goods as well, are usually prepared using injection molding. For this purpose, the material for molding is produced by mixing the selected rubber or synthetic compound with fillers, plasticizers, stabilizers and coloring agents known in the art. The prepared material is then injected into the mold cavity using an injection molding machine. After the mold is cooled in order to solidify the material, the sole is further treated for example by cutting edges. In a further process step, the produced outsole is then integrated into the shoe manufacturing process by attaching it to the shoe midsole, upper or other elements using adhesives, stitching or other assembly techniques.

A common disadvantage of these soles is that the final sole has a specific weight and thickness in order to provide for the required durability and performance of the shoe, which significantly impacts the total shoe weight. Another common disadvantage of the soles is that they are not sustainable as the shoe is designed to be disposed after usage. In addition, it is not easily possible to change the material properties during the manufacturing process for adapting the sole to the diverse requirements of the sporting good. Also, soles are usually produced in several independent steps, which results in an overall labor intensive and inefficient process.

Therefore, the underlying problem of the present disclosure is to provide improved methods and sporting goods in order to at least partly overcome the above-mentioned deficiencies.

### BRIEF SUMMARY

The present disclosure is directed to an outsole for a sporting good. The outsole can be manufactured via production of a liquefied polymer by mixing the polymer and a solvent. The mixture can be applied and cured on the sporting good. In this manner, the liquefied polymer can be applied more precisely and effectively on the sporting good, as no material waste is produced e.g. by cutting excess material. In this manner, the methods according to present disclosure provide improved methods for producing a component of e.g., a sporting good, by only consuming as much material as needed and avoiding any waste production.

A first embodiment (I) of the present disclosure is directed to a method (100) for producing a component (240), preferably for a sporting good (260), comprising the following steps: a. providing (110) a polymer; b. providing (120) a solvent (220); c. mixing (130) the polymer with the solvent (220), thereby producing a liquefied polymer (230); and d. curing (170) the liquefied polymer (230), thereby producing the component (240).

In a second embodiment (II), in the method (100) according to the first embodiment (I), the component is a first component of the sporting good and the method further comprises the step of depositing (150) the liquefied polymer (230) obtained in the mixing step (130) onto a second component (250) of the sporting good (260), and the depositing step (150) precedes the curing step (170).

In a third embodiment (III), in the method (100) according to the second embodiment (II) further comprises the step of texturing (160) the liquefied polymer (230) obtained in the mixing step (130), wherein the texturing step (160) precedes the curing step (170).

In a fourth embodiment (IV), in the method (100) according to any one of embodiments (I)-(III), the sporting good (260) is a sports shoe (270).

In a fifth embodiment (V), in the method (100) according to the fourth embodiment (IV), the component (240) is a sole (280), preferably an outsole (290) of the sports shoe (270).

In a sixth embodiment (VI), in the method (100) according to the fourth embodiment (IV) or the fifth embodiment (V), the sports shoe (270) is a football shoe (275).

In a seventh embodiment (VII), in the method (100) according to any one of embodiments (IV)-(VI), the component (240) is a stud (285) of the sports shoe (270).

In an eighth embodiment (VIII), in the method (100) according to any one of embodiments (IV)-(VII), the liquefied polymer (230) is deposited onto one or more sections of the sports shoe (270), including a toe section, a forefoot section, a heel section, a midsole section, a sidewall section and/or an upper section.

In a ninth embodiment (IX), the method (100) according to any one of embodiments (II)-(VIII), wherein the liquefied polymer (230) is deposited onto one or more predetermined portions of the sporting good (260).

In a tenth embodiment (X), in the method (100) according to the ninth embodiment (IX), one or more predetermined portions of the sporting good (260) is/are determined using a torsion map, an abrasion map and/or a pressure map.

In an eleventh embodiment (XI), in the method (100) according to any one of embodiments (II)-(X), the liquefied polymer (230) is deposited onto the second component in a pattern (300).

In a twelfth embodiment (XII), in the method (100) according to the eleventh (XI) embodiment, the pattern (300) comprises a laminar and/or a linear pattern.

In a thirteenth embodiment (XIII), in the method (100) according to any one of embodiments (II)-(XII), the first component (240) is deposited onto the second component with a thickness of 1-10 mm, preferably 2 mm-4 mm, most preferably 3 mm.

In a fourteenth embodiment (XIV), in the method (100) according to any one of embodiments (II)-(XIII), the thickness of the first component (240) after the curing step is 0.3 mm-0.7 mm, preferably 0.5 mm.

In a fifteenth embodiment (XV), in the method (100) according to any one of embodiments (II)-(XIV), the depositing step (150) is carried out by at least one of the following methods: brushing, coating, dipping, painting, automated dispensing, automated printing, controlled dispensing.

In a sixteenth embodiment (XVI), in the method (100) according to any one of embodiments (II)-(XV), the second component (250) is produced via 3D printing, and preferably the second component (250) is a mid-sole and/or a shoe upper and/or parts thereof.

In a seventeenth embodiment (XVII), in the method (100) according to any one of embodiments (II)-(XVI), the liquefied polymer (230) is deposited in a first section of the sporting good (260) with a dynamic viscosity of 30000 to 50000 mPa·s; and in a second section of the sporting good (260) with a dynamic viscosity of 10000 to 30000 mPa·s.

In an eighteenth embodiment (XVIII), in the method (100) according to the seventeenth embodiment (XVII), the first section is an outer rim of the second section of the sporting good (260).

In a nineteenth embodiment (XIX), in the method (100) according to any one of embodiments (II)-(XVIII), the contact angle θ between the liquefied polymer (230) and the second component (250) is 30° to 110°, preferably 40° to 90°, more preferably 50° to 70°.

In a twentieth embodiment (XX), in the method (100) according to any one of embodiments (I)-(XIX), the curing step (170) is carried out using radiation.

In a twenty-first embodiment (XXI), in the method (100) according to any one of embodiments (I)-(XX), the polymer is selected from the group of polyurethanes (PU), thermoplastic polyamides (TPE-A or TPA), thermoplastic polyesters (TPE-E or TPE), thermoplastic styrenic block copolymers (TPE-S or TPS), thermoplastic polyurethanes (TPE-U or TPU), thermoplastic vulcanizates (TPE-V or TPV), rubber or ethylene-vinyl copolymer (EVA), preferably thermoplastic polyurethanes (TPE-U or TPU), and/or combinations thereof.

In a twenty-second embodiment (XXII), in the method (100) according to any one of embodiments (I)-(XXI), the solvent (220) is a mixture (225) selected from the group of solvent-borne and/or water-borne solvents, preferably from the group of solvent-borne solvents, more preferably from the group of (C₁-C₆) ethers, (C₁-C₁₀) esters, (C₁-C₈) ketones, (C₁-C₈) alkanes, and/or combinations thereof.

In a twenty-third embodiment (XXIII), in the method (100) according to the twenty-second embodiment (XXII), the solvent (220) is a mixture (225) of solvents comprising tetrahydrofuran (THF), methyl ethyl ketone (MEK), cyclohexane (CYC), ethyl acetate, butyl acetate, preferably THF and/or CYC.

In a twenty-fourth embodiment (XXIV), in the method (100) according to the twenty-third embodiment (XXIII), the ratio of the mixture (225) of solvents is in the range of 10 to 90 vol. %, preferably 20 to 80 vol. %, more preferably 30 to 70 vol. %.

In a twenty-fifth embodiment (XXV), in the method (100) according to the twenty-third embodiment (XXIII), the ratio of the mixture (225) of solvents is in the range of 10 to 90 wt. %, preferably 20 to 80 wt. %, more preferably 30 to 70 wt. %.

In a twenty-sixth embodiment (XXVI), in the method (100) according to any one of embodiments (I)-(XXV), the liquefied polymer (230) comprises a dynamic viscosity of 10000 to 50000 mPa·s, preferably of 20000 to 40000 mPa·s.

In a twenty-seventh embodiment (XXVII), in the method (100) according to any one of embodiments (I)-(XXVI), the polymer is characterized by a Shore A value (190) and/or Shore D value (195), wherein the Shore A value (190) is in the range of 20 to 120, preferably, 40 to 100, more preferably, 60 to 80; and the Shore D value (195) is in the range of 2 to 80, preferably 5 to 75, more preferably 8 to 70.

In a twenty-eighth embodiment (XXVIII), in the method (100) according to any one of embodiments (I)-(XXVII), the ratio of the polymer to the solvent (220) in the mixing step (130) is in the range of 2:98 to 40:60 vol. %, preferably, 5:95 to 30:70 vol. %, more preferably, 10:90 to 20:80 vol. %.

In a twenty-ninth embodiment (XXIX), in the method (100) according to any one of embodiments (I)-(XXVIII), the liquefied polymer (230) further comprises pigments and/or fibers.

In a thirtieth embodiment (XXX), in the method (100) according to any one of embodiments (I)-(XXIX), the liquefied polymer (230) further comprises granulates.

In a thirty-first embodiment (XXXI), in the method (100) according to any one of embodiments (I)-(XXX), in the curing step (170) a curing temperature of between 20° C. to 150° C., preferably 30° C. to 100° C., more preferably 40° C. to 50° C. is used, and the curing time is between 2 min to 750 min, preferably, 5 min to 390 min, more preferably 10 min to 30 min.

A thirty-second embodiment (XXXII) of the present disclosure is directed to a method (1000), comprising the method (100) of any one of embodiments (I)-(XXXI), wherein the first component is an outsole (290) of the sports shoe (270) and the second component is a midsole (350) of the sports shoe (270).

A thirty-third embodiment (XXXIII) of the present disclosure is directed to an outsole manufactured according to the method (100) of any one of embodiments (I)-(XXII).

In a thirty-fourth amendment (XXXIV), in the outsole according to the thirty-third embodiment (XXXIII), the outsole comprises a pattern (300).

A thirty-fifth embodiment (XXXV) of the present disclosure is directed to a sports shoe comprising an outsole according to the thirty-third embodiment (XXXIII) or the thirty-fourth embodiment (XXXIV).

In a thirty-sixth embodiment (XXXVI), in the sports shoe according to the thirty-fifth embodiment (XXXV), the outsole (290) is arranged at least in a toe section (10), a mid-foot section (15), and/or a heel section (20) of the sports shoe.

A thirty-seventh embodiment (XXXVII) of the present disclosure is directed to a sports shoe comprising a first component and a second component, wherein the first component is manufactured according to any of embodiments (II)-(XXXII), wherein the first component is arranged on an upper of the sports shoe.

### BRIEF DESCRIPTION OF THE FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 illustrates a flow diagram illustrating a method for producing a component, such as for a sporting good, according to some embodiments.

FIG. 2 illustrates a sports shoe comprising the component of FIG. 1 according to some embodiments.

FIG. 3 illustrates the component of FIG. 1 according to some embodiments.

FIG. 4 illustrates the component of FIG. 1 according to some embodiments.

FIG. 5 illustrates the component of FIG. 1 according to some embodiments.

FIG. 6 illustrates the component of FIG. 1 according to some embodiments.

FIG. 7 illustrates a sports shoe according to some embodiments.

FIG. 8 illustrates exemplary zones for deposition of the liquefied polymer according to some embodiments.

FIG. 9 illustrates exemplary zones for deposition of the liquefied polymer according to some embodiments.

FIG. 10 illustrates exemplary zones for deposition of the liquefied polymer according to some embodiments.

FIG. 11 illustrates exemplary zones for deposition of the liquefied polymer according to some embodiments.

### DETAILED DESCRIPTION

The indefinite articles “a,” “an,” and “the” include plural referents unless clearly contradicted or the context clearly dictates otherwise.

The term “comprising” is an open-ended transitional phrase. A list of elements following the transitional phrase “comprising” is a non-exclusive list, such that elements in addition to those specifically recited in the list can also be present. The phrase “consisting essentially of” limits the composition of a component to the specified materials and those that do not materially affect the basic and novel characteristic(s) of the component. The phrase “consisting of” limits the composition of a component to the specified materials and excludes any material not specified.

The term “component” according to present disclosure can refer to, but is not limited to, a unit or module that performs a specific function within a larger system. A component can be, for example, a component used in the manufacturing process of a sporting good, such as a sole unit, a midsole, an outsole, an outsole element, a film or foil material, a sole plate, a shoe upper, a functional element.

The term “sporting good” according to present disclosure can refer to, but is not limited to, any equipment, gear or product designed and/or used specifically for sports. Sporting goods can be, e.g., sports clothing, sports shoes, sports accessories, and/or sports equipment.

The term “polymer” according to present disclosure can refer to, but is not limited to, a large molecule based on repeating subunits (monomers), which are bound together and form a network structure. Polymers can be classified as the following: Synthetic polymers, natural polymers, biodegradable polymers, composite polymers.

The term “solvent” according to present disclosure can refer to, but is not limited to, a compound capable of dissolving, dispersing, or extracting other compounds. Solvents can be be polar or nonpolar. Common solvents are in liquid form but may be also a gas or a solid.

The term “mixing” according to present disclosure can refer to, but is not limited to, a process of combining two or more substances resulting in a mixture of the individual substances.

The term “curing” according to present disclosure can refer to, but is not limited to, a chemical and/or physical process of a substance that typically promotes hardening, setting and/or solidification of the same. Curing can be based on chemical reactions, heat influences and/or other external or internal factors.

The terms “depositing” or “deposition” can refer to, but are not limited to, processes of applying one or more elements to other one or more elements.

The terms “texturing” or “structuring” can refer to, but are not limited to, processes of manipulating physical properties of an element by external influence, e.g. shape, pattern and/or surface.

Where a range of numerical values comprising upper and lower values is recited herein, unless otherwise stated in specific circumstances, the range is intended to include the endpoints thereof, and all integers and fractions within the range. It is not intended that the disclosure or claims be limited to the specific values recited when defining a range. Further, when an amount, concentration, or other value or parameter is given as a range, one or more ranges, or as list of upper values and lower values, this is to be understood as specifically disclosing all ranges formed from any pair of any upper range limit or value and any lower range limit or value, regardless of whether such pairs are separately disclosed.

As described above, producing a component, such as an outsole for a sporting good, usually is carried out by e.g. injection molding a first component to a second component. However, such a process is not flexibly adaptable to the special needs of the product. Additionally, gluing processes may require complex pretreatment of the components and additionally adhesives used for the gluing of plastic components are often harmful or environmentally hazardous.

Embodiments of the present disclosure are directed to an outsole for a sporting good that can be manufactured via production of a liquefied polymer by mixing the polymer and a solvent. The mixture can be applied and cured on the sporting good to more precisely and effectively coat the sporting good and reduce waste. In this manner, the methods according to present disclosure provides for improved methods for producing a component of e.g., a sporting good, by only consuming as much material as needed and avoiding any waste production. Furthermore, no manual assembly is required as well as a glue-less application is possible, providing for an efficient process with reduced material consumption and consequently reduced overall costs, that is applicable to automated processes. Furthermore, embodiments of the present disclosure can significantly improve durability and lifetime of a sporting good.

Following this approach, the component according to embodiments of the present disclosure can be provided and cured more than once, which allows for the strategic production of components having different thickness and weight while significantly improving the performance and durability of the sporting good and maintaining or even increasing the cushioning properties of the same. In this manner, methods according to embodiments of the present disclosure allow for a mold-less production method, while being able of flexibly addressing different needs and requirements of the product. Therefore, the present disclosure significantly simplifies the overall process for producing components, preferably for a sporting good as well as enhances overall sustainability of the process as renewing of worn products, i.e. recoating and re-application of the component is possible. This can significantly help to extend the lifetime of the sporting goods by renewing the respective component. Finally, this can further help to reduce overall waste production by the consumer. By choosing sustainable starting materials (polymer, solvent) in the methods according to the present disclosure, the produced component and sporting good is recyclable and produced in a sustainable manner. Moreover, the component may provide a shiny and/or glossy appearance, which can be regarded as advantageous from a visual perspective.

Therefore, the whole manufacturing process of the sporting good using the methods according to present disclosure may be more efficient and sustainable. The methods according to the present disclosure provides the possibility that the curing process provided to different portions of the sporting good may be adjusted easily so that the component is cured on the sporting good without wasting an excessive amount of energy and time. Moreover, the methods according to the present disclosure allows for the possibility of creating patterns and designs by the use of the component that may vary in their design and shape. For example, the component can be transparent, non-transparent, uni- or multicolored as well as individualized by the consumer.

The above-mentioned problems are at least partly solved by methods for producing a component, preferably for a sporting good, comprising the following steps: a.) providing a polymer; b.) providing a solvent; c.) mixing the polymer with the solvent, thereby producing a liquefied polymer; and d.) curing the liquefied polymer, thereby producing the component.

In some embodiments, the methods according to the present disclosure may further comprise a depositing step of the liquefied polymer obtained in the mixing step, which may be a first component of the sporting good, onto a second component of a sporting good. The depositing step may precede the curing step. “Depositing” or “deposition” according to present disclosure can refer to, but is not limited to, processes of applying one or more elements to other one or more elements. Such embodiments can significantly simplify the process of producing the component. For example, the liquefied polymer can be deposited with different physical characteristics before curing the polymer on the sporting good, enhancing the efficiency of the manufacturing process. Moreover, these method steps may be performed in one device or may be performed at different entities to provide a high degree of flexibility and automation in the production process.

Methods according to the present disclosure may further comprise the step of texturing the liquefied polymer obtained in the mixing step, and which may precede the curing step. “Texturing” or “structuring” according to present disclosure can refer to, but is not limited to, processes of manipulating physical properties of an element by external influence, e.g. shape, pattern and/or surface. The addition of textures and structures can significantly improve the performance and durability of the sporting good, as the thickness of the applied layer can be adapted to product requirements, such as weight, abrasion resistance and design. The texturing may be performed using common texturing devices, e.g. pattern brushes and/or pattern roller. The choice of the texturing device depends on the desired pattern and/or the physical characteristic of the liquefied polymer.

In some embodiments, the sporting good may be a sports shoe. A sports shoe is, for example, a football shoe, basketball shoe, running shoe, tennis shoe, motorsport shoe, hiking shoe and so forth. When applied to a sports shoe, the methods according to the present disclosure can significantly improve its lifetime and durability as well as reducing the overall weight of the sports shoe.

The component may be the sole, or the outsole of the sports shoe. In this manner, the sole is manufactured by the methods according to the present disclosure and allows for equal or even and more durable properties by using one or more lighter and thinner soles and/or outsoles as compared to usual soles known in the art.

In some embodiments, the sport shoe may be a football shoe. In this manner, the football shoe shows enhanced physical properties compared to football shoes known in the art. Specifically, a football shoe made in accordance with methods according to the present disclosure is lighter while maintaining the same and even better performance characteristics than usual football shoes.

In some embodiments, the component may be a stud of the sports shoe. Besides the advantage of being lighter while maintaining the same and even better performance characteristics than usual sports shoes with studs, it allows for the possibility of individually recoating and/or renewing each stud. Depending on the diverse needs of the product and/or the consumer, the studs may be formed and textured individually. In this manner, it is possible to design strategically and conceptually each sports shoe comprising studs, thereby providing for improved methods.

In some embodiments, the liquefied component may be deposited onto one or more sections of the sports shoe. The sections may include a toe section, a forefoot section, a heel section, a midsole section, a sidewall section, and/or an upper section. The “liquefied component” can refer to, but is not limited to, a component having semi-solid physical properties and/or the liquefied polymer according to embodiments of the present disclosure. In this manner, the sports shoe can comprise individual sole elements that can be adapted and re-applied. The liquefied component may be deposited on predetermined portions of the sporting good. For example, the liquefied component may comprise different physical properties on each of the predetermined portions. In this manner, the sporting good may be conceptually adapted while allowing for a lighter total weight of the sporting good as well as enhancing its durability and performance characteristics.

The one or more predetermined portions of the sporting good may be determined using a torsion map, an abrasion map and/or a pressure map. Using this approach, the component can be applied in defined areas where it is most required. These predetermined areas or defined areas can for example be described as “the highest general wear zones”. The deposition application is adapted to each map by adapting the physical properties and in particular the thickness of the liquefied polymer and/or component based on the zones deriving from the maps. These zones are characterized e.g. in that high pressure, traction and/or abrasion takes place. The liquefied polymer can be applied with different thickness and weight onto the predetermined areas in order to fulfill the abrasion and traction requirements. Furthermore, in this manner, weight reduction, performance, lifetime, and/or durability of the sporting good is enhanced.

In some embodiments, the liquefied component may be deposited onto the second component in a pattern. The advantage of methods according to the present disclosure is an individualized and adapted application of the liquefied component that requires less material and thus is cost-effective. Moreover, the liquefied component may provide a shiny and/or glossy appearance. The pattern may comprise a laminar and/or linear pattern. In this manner, methods according to the present disclosure can be applied for both linear forms and designs as well as for large uniform laminar designs. This provides the advantage of creating islands with more or less liquefied components, which are adapted to the individual requirements of the product and/or consumer.

The first component may be deposited onto the second component with a thickness of 1-10 mm, 2 mm-4 mm, or 3 mm. When applying the component with the specific thickness enhances the performance of the sporting good as well as achieves the same or even enhanced results for its durability properties when compared to commercial components.

The thickness of the first component after the curing step may be 0.3 mm-0.7 mm, or 0.5 mm. The specific thickness of the component provides the benefit that the component is showing the same or even better performance and/or durability properties while having a reduced weight and thickness.

In some embodiments, the depositing step may be carried out by at least one of the following methods: brushing, coating, dipping, painting, automated dispensing, automated printing, or controlled dispensing. These specific deposition processes represent the best mode for deposition of the liquefied polymer. The choice of the deposition process is dependent on the characteristics of the liquefied polymer and the second component of the sporting good.

In some embodiments, the second component may be produced via 3D printing, wherein the second component may be a midsole and/or a shoe upper and/or parts thereof. The liquefied polymer may be subsequently applied onto the second component wherein the liquefied polymer may be an outsole. 3D printing comprises additive manufacturing methods, such as stereolithographic methods and laser sintering. With stereolithographic methods light causes chemical monomers and oligomers to cross-link together to form layer-wise polymers making up the 3D printed object. With laser sintering a laser causes powdered material to sinter due to heat. Aiming the laser at points in space defined by a 3D model, binding the material together creates a solid structure. Another example of an additive manufacturing method is fused deposition modeling in which the part is produced by extruding small beads or streams of material that harden immediately to form layers. If both the midsole and the upper are manufactured using a 3D printing process, the midsole and the upper may be manufactured in separate 3D printing processes and connected afterwards, e.g. by gluing, welding sewing, etc. Alternatively, the midsole and the upper may be manufactured together in a single manufacturing step.

In another embodiment, the second component is a midsole made from a polymer material and the liquefied polymer is applied onto the midsole, thus forming an outsole. In this embodiment, the polymer material may be an Ethylene-vinyl acetate (EVA), a thermoplastic urethane (TPU) or a supercritical foam. Those materials provide good cushioning properties while being relatively lightweight.

In some embodiments, the liquefied polymer may be deposited in a first section of the sporting good with a dynamic viscosity of 30,000 to 50,000 mPa·s; and in a second section of the sporting good with a dynamic viscosity of 10,000 to 30,000 mPa·s. Different viscosities may be obtained by varying the mixing ratio of the solvent and the polymer. In this manner, it is possible to deposit different viscous materials on the second component by using one operation step. Methods according to the present disclosure allow for flexible adaptation of the operation step based on the needs of the product.

The first section may be an outer rim of the second section of the sporting good. This feature allows for quick and easy deposition onto the second component using only one operation step, for the deposition of one pattern onto the sporting good.

In some embodiments, the contact angle θ between the liquefied polymer and the second component is 30° to 110°, 40° to 90°, or 50° to 70°. These wettability characteristics allow for deposition of the liquefied polymer onto the second component.

The curing step may be carried out using radiation. In this way, the liquefied component that is deposited on the second component is cured on the second component while at the same time removing the solvent and drying the deposited liquefied component.

In some embodiments, the polymer may be selected from the group of polyurethanes (PU), thermoplastic polyamides (TPE-A or TPA), thermoplastic polyesters (TPE-E or TPE), thermoplastic styrenic block copolymers (TPE-S or TPS), thermoplastic polyurethanes (TPE-U or TPU), thermoplastic vulcanizates (TPE-V or TPV), rubber or ethylene-vinyl copolymer (EVA), preferably thermoplastic polyurethanes (TPE-U or TPU), and/or combinations thereof. Use of these polymer allows for a time efficient and sustainable process in the production of the component. Suitable polymer materials may be elastic foam materials, such as thermoplastic elastomers and/or elastomers. In some embodiments, the thermoplastic elastomers can comprise urethane-based thermoplastic elastomers (TPU), polyester-based thermoplastic elastomers (TPE) and/or polyamide-based thermoplastic elastomers (TPA).

In some embodiments, the solvent is a mixture selected from the group of solvent-borne and/or water-borne solvents, or from the group of solvent-borne solvents, or from the group of (C₁-C₆) ethers, (C₁-C₁₀) esters, (C₁-C₈) ketones, (C₁-C₈) alkanes, and/or combinations thereof. These solvents have shown the best compatibility with the production methods of the component according to the present disclosure, while allowing for flexible adaptation of physical characteristics of the polymer to the requirements of the product and the process.

The solvent may be a mixture of two or more of tetrahydrofuran (THF), methyl ethyl ketone (MEK), cyclohexane (CYC), ethyl acetate, or butyl acetate, preferably THF and/or CYC. These solvents have the advantage that they can be removed in a time efficient manner during the curing process and allow for a production process that is capable of adapting to various physical properties of the liquid polymer.

The ratio of the mixture may be in the range of 10 to 90 vol. %, 20 to 80 vol. %, more preferably or 30 to 70 vol. %. In some embodiments, the ratio of the mixture may be in the range of 10 to 90 wt. %, 20 to 80 wt. %, or 30 to 70 wt. %. The ratio of the mixture of the solvent shows the best compatibility for both mixing the polymer and changing/adapting the physical characteristics of the liquefied polymer to the special requirements of the product and the process.

In some embodiments, the liquefied component may comprise a dynamic viscosity of 10,000 to 50,000 mPa·s or 20,000 to 40,000 mPa·s. The use of the liquid polymer comprising the specific dynamic viscosity allows for its use in automated and/or manual deposition processes.

The polymer may be characterized by a Shore A value and/or Shore D value, wherein the Shore A value is in the range of 20 to 120, 40 to 100, or 60 to 80; and the Shore D value is in the range of 2 to 80, 5 to 75, or 8 to 70. The use of a polymer comprising these Shore A and/or Shore D values provide for the durable properties of the final component. Suitable polymer materials are elastic foam materials, such as thermoplastic elastomers (TPE) and/or elastomers.

The ratio of the polymer to the solvent in the mixing step may be in the range of 2:98 to 40:60 vol. %, 5:95 to 30:70 vol. %, or 10:90 to 20:80 vol. %. The specific ratio of solvent to the polymer allows for convenient use in the deposition process and flexible adaptation to the requirements of the product and/or process.

In some embodiments, the liquefied polymer may further comprise pigments and/or fibers. This allows for an increased stiffness and durability in the selected areas of application. “Fibers” can refer to, but is not limited to, threads or filaments based on natural and/or synthetic materials.

The liquefied polymer may further comprise granulates. In this manner, the traction and grip properties are enhanced in selected areas of the sporting good based on the use of the granulates. “Granulates” can refer to, but is not limited to, particles with different sizes and shapes, which may have specific physical properties based on natural and/or synthetic materials.

In some embodiments, the curing step can comprise a curing temperature of between 20° C. to 150° C., 30° C. to 100° C., or 40° C. to 50° C. is used, and the curing time of between 2 min to 750 min, preferably, 5 min to 390 min, more preferably 10 min to 30 min. These curing conditions can allow for the cost- and energy-efficient process for the production of the component.

In some embodiments, methods according to the present disclosure can relate to a method for manufacturing a sports shoe, comprising methods according to the present disclosure, wherein the first component is an outsole of the sports shoe, and the second component is a midsole of the sports shoe. The advantages of the methods for manufacturing a sports shoe are avoiding e.g. glue- and injection molding-based deposition of the outsole to the midsole of the sports shoe.

In some embodiments, methods according to the present disclosure relate to an outsole manufactured according to methods of the present disclosure. The component can be specifically used to create a lighter and thinner outsole while still allowing for the same and/or even enhanced performance and durability of the same.

The outsole can comprise a pattern. In this manner, the outsole can be individually designed based on the needs and requirements of the product and/or consumer.

In some embodiments, methods according to the present disclosure relate to a sports shoe comprising an outsole according to the present disclosure. The sports shoe comprising the outsole according to present disclosure is lighter and thinner, making the overall sports shoe more desirable. In addition, the sports shoe exhibits the same and/or even enhanced durability and performance properties than sports shoes known in the art.

The outsole may be arranged at least in a toe section, a mid-foot section, and or a heel section of the sports shoe. This provides the benefit that the outsole can be placed in specific portions of the sports shoe, allowing for weight reduction and material- and cost-saving.

In some embodiments, methods according to the present disclosure relate to a sports shoe comprising a first component and a second component, wherein the first component is manufactured according to methods of the present disclosure, wherein the first component is arranged on an upper of the sports shoe. The sports shoe comprising the component according to the present disclosure is lighter and thinner, making the overall sports shoe more desirable while showing the same and/or even enhanced durability and performance properties than sports shoes known in the art.

Possible embodiments and variations of the present disclosure are described in the following with particular reference to a sporting good, in particular a sports shoe. However, the concept of the present disclosure is not limited to these embodiments. The methods described herein may identically or similarly be applied to the manufacture of any sporting goods in general, such as, for example, sports clothing or sports equipment.

It is also to be noted that individual embodiments of the disclosure are described in greater detail below. However, it is clear to the person skilled in the art that the constructional possibilities and optional features described in relation to these specific embodiments can be further modified and combined with one another in a different manner within the scope of the present disclosure and that individual steps or features can also be omitted where they appear to be unnecessary to the skilled person. In order to avoid redundancies, reference is made to the explanations in the previous sections, which also apply to the embodiments of the following detailed description.

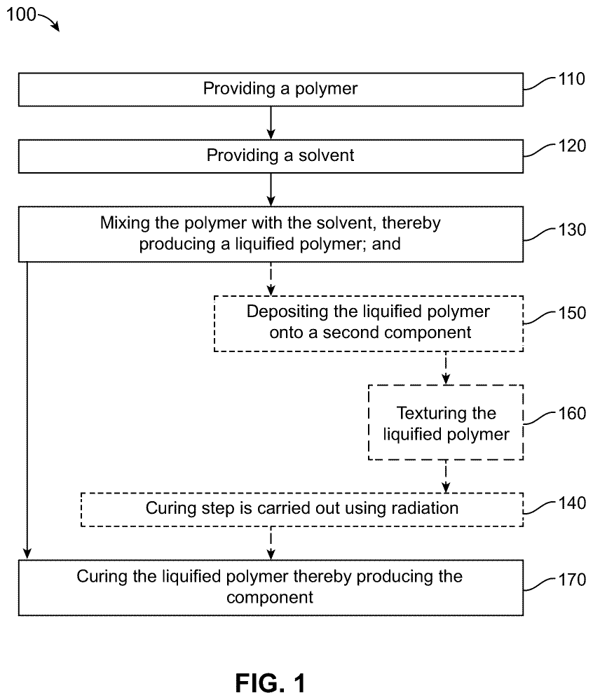

FIG. 1. presents a flow diagram illustrating a method 100 for producing a component 240 according to some embodiments, such as a sporting good 260. In some embodiments, the method 100 begins with the method step 110 with providing a polymer. In some embodiments, the polymer is selected from the group of elastomers and/or thermoplastic elastomers. Preferred materials from the group of elastomers are block foams, such as ethylene-vinyl-acetate (EVA), polyurethanes (PU) and/or rubber. Thermoplastic elastomers (TPE) are bead-, block foams, cross-linked, and/or un-cross-linked and are classified using the following groups: TPE-O or TPO; TPE-V or TPV; TPE-U or TPU; TPE-E or TPE or TPC; TPE-S or TPS; TPE-A or TPA. Polymer materials from the group of TPE-O or TPO are polypropylene (PP), ethylene propylene diene rubber or ethylene propylene diene monomer rubber (EPDM). Preferred polymer materials from the group of TPE-V or TPV are thermoplastic vulcanizates such as SARLINK®. Polymer materials from the group of TPE-U or TPU are further classified in ester based, ether based, or linear UP materials. For instance, a preferred ester-based TPU material is e.g. HUNTSMAN-H FOAM®. For example, a preferred ether-based TPU material is, e.g., ELASTOLLAN® 11XX (BASF). Preferred polymer materials from the group of TPE-E or TPC are e.g. HYTREL® (DuPont), KEYFLEX® (LG) and/or ARNITEL® (DSM). A preferred polymer material from the group of TPE-S or TPS is, for example, STYROFLEX® (BASF). Preferred polymer materials from the group of TPE-A or TPA are from the group of polyether block amides, such as PEBAX®, and/or VESTAMID®. The polymer in the method step 110 is characterized in that it comprises a Shore A and/or D value. The Shore A value is in the range of 20 to 120, 40 to 100, or 60 to 80; and the Shore D value is in the range of 2 to 80, 5 to 75, or 8 to 70.

In some embodiments, the second step in the method 100 is the method step 120 with providing a solvent. Suitable solvents are solvents selected from the group of solvent-borne and/or water-borne solvents, from the group of solvent-borne solvents, from the group of (C₁-C₆) ethers, (C₁-C₁₀) esters, (C₁-C₈) ketones, (C₁-C₈) alkanes, and/or combinations thereof. The solvent is, for example, a mixture of two or more of the solvents comprising tetrahydrofuran (THF), methyl ethyl ketone (MEK), cyclohexane (CYC), Dimethylacetamide (DMAC), Dimethyl sulfoxide (DMSO), N-Methylpyrrolidone (NMP), ethyl acetate, butyl acetate, THF and/or CYC. In some embodiments, the ratio of the mixture of two solvents is in the range of 10 to 90 vol. %, 20 to 80 vol. %, or 30 to 70 vol. %.

In some embodiments, in the third method step 130 of the method 100, the polymer and the solvent are mixed, thereby producing a liquefied polymer 230. The ratio of the polymer to the solvent in the mixing step is in in the range of 2:98 to 40:60 vol. %, 5:95 to 30:70 vol. %, or 10:90 to 20:80 vol. %. The ratio of the polymer to the solvent in the mixing step is in in the range of 10 to 90 wt. %, 20 to 80 wt. %, or 30 to 70 wt. %. In some embodiments, a color pigment can be mixed with the polymer and the solvent. The color pigment can comprise less than 1 wt. % and/or less than 1 vol. % of the mixture.

As shown in FIG. 1, in some embodiments, the method 100 can comprise the optional method steps 150 and 160. In some embodiments, these steps precede the curing step 170. In some embodiments, in the method step 150, the liquefied polymer 230 is deposited onto a second component 250. The liquefied polymer 230 is deposited onto the second component 250 with a thickness of 1-10 mm, 2 mm-4 mm, or 3 mm. Furthermore, in some embodiments, the liquefied polymer 230 is deposited onto one or more sections of the sports shoe. These sections include a toe section, a forefoot section, a heel section, a midsole section, a sidewall section, and/or an upper section. In some embodiments, the liquefied polymer 230 is deposited in predetermined portions that are determined using a torsion map, an abrasion map and/or a pressure map as will be described in more detail below. In some embodiments, the liquefied polymer is deposited in the depositing step 150, which is carried out by at least one of the following methods: brushing, coating, dipping, painting, automated dispensing, automated printing, or controlled dispensing. In some embodiments, the liquefied polymer 230 is deposited via automated printing, wherein the second component is a midsole and/or a shoe upper or parts thereof, or both. In some embodiments, the deposition of the second component as the shoe upper and/or the midsole is carried out in a one-process-step, such as via 3D printing. In some embodiments, the liquefied polymer is subsequently applied onto the second component wherein the liquefied polymer is the outsole 290. In some embodiments, the deposition step is carried out by an automated process. In some embodiments, the liquefied polymer 230 for depositing can comprise a dynamic viscosity of 10000 to 50000 mPa·s, or 20000 to 40000 mPa·s. Unless specified otherwise, the dynamic viscosity is measured using a rotational viscometer at room temperature. In some embodiments, the liquefied polymer is deposited at room temperature.

In some embodiments, in order to speed up the deposition process, the outer rim of the area of the sporting good, which is targeted during the deposition step, is dispensed using a thin nozzle and using the liquefied polymer 230 with a higher dynamic viscosity to achieve precise placement of the liquefied polymer 230. In some embodiments, a thin nozzle can comprise a nozzle with an opening diameter of less than or equal to 2 mm. In some embodiments, using a thin nozzle can result in a line of the liquefied polymer 230 that is less than or equal to 3 mm wide. Secondly, the area inside of the rim is dispensed in a quicker process using a wide nozzle and a liquefied polymer with a lower dynamic viscosity. In some embodiments, a wide nozzle can comprise a nozzle with an opening diameter of greater than 2 mm. In some embodiments, using a wide nozzle can result in a line of the liquefied polymer 230 that is greater than 3 mm wide. In some embodiments, the thin nozzle and the wide nozzle can comprise diameters other than those disclosed above, where the diameter of the wide nozzle is larger than the diameter of the thin nozzle. Therefore, in some embodiments, the liquefied polymer is deposited in a first section of the sporting good with a dynamic viscosity of 30,000 to 50,000 mPa·s; and in a second section of the sporting good with a dynamic viscosity of 10,000 to 30,000 mPa·s. The second section is the area, which is positioned in between the first area. The first section is the outer rim of the second section of the sporting good 260.

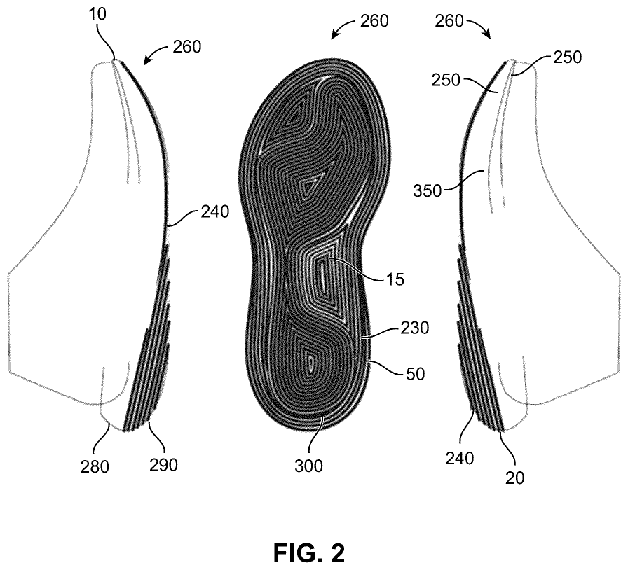

In some embodiments, during deposition, the contact angle θ between the liquefied polymer 230 and the second component 250 is 30° to 110°, 40° to 90°, or 50° to 70°. In some embodiments, the deposition is an automated deposition process. In some embodiments the liquefied polymer 230 can comprise granulates. In some embodiments, the liquefied polymer 230 can comprise pigments and/or fibers. In some embodiments, as depicted for example in FIGS. 2 and 4, the liquefied polymer 230 is deposited onto the second component 250 in a pattern. In some embodiments, the pattern can comprise a laminar and/or linear pattern.

In some embodiments, after deposition, the liquefied polymer 230 may be textured during optional method step 160. In some embodiments, the addition of textures to the deposited liquefied polymer 230 is performed using texturing devices known in the art, such as a pattern brush and/or a pattern roller. In some embodiments, the addition of textures and structures may further be performed by pressing patterns via pattern devices in the deposited semi-dried liquefied polymer 230.

In some embodiments, in the last method step 170 of the method 100, the liquefied polymer is cured. In this way, the liquefied polymer 230, which in some embodiments may be deposited on a second component 250, is cured while at the same time the solvent(s) existent in the liquefied polymer 230 are removed. In some embodiments, the solvent may be removed via condensation and the condensates may be recycled. In some embodiments, the curing temperature in the curing step 170 is between 20° C. to 150° C., 30° C. to 100° C., or 40° C. to 50° C., and the curing time is between 2 min to 750 min, 5 min to 390 min, or 10 min to 30 min. In some embodiments the curing step 170 is carried out using radiation. In some embodiments, curing step 170 can be performed using infrared radiation (IR). However, other types of radiation are applicable. In some embodiments, the thickness of the component 240 after the curing step is 0.3 mm-0.7 mm, or 0.5 mm.

In some embodiments, the sporting good 260 obtained in part by the method 100 illustrated in FIG. 1. In some embodiments, the sporting good 260 can be a sports shoe. Specifically, in some embodiments, the component 240 is a sole, such as an outsole of the sports shoe. Furthermore, in some embodiments, the sports shoe obtained in part by the method 100 is a football shoe. In some embodiments, the component is a stud of the sports shoe. In some embodiments, the sporting good 260 can comprise at least two components, a first and a second component. In some embodiments, the first component is an outsole 290, which is produced according to the method 100 illustrated in and described with respect to FIG. 1. In some embodiments, the second component is a midsole 350 of the sporting good 260.

In some embodiments, the sporting good 260 depicted in FIG. 2 is a sports shoe. FIG. 2 illustrates an exemplary outsole of the sporting good 260 produced by the methods according to the present disclosure in accordance with certain embodiments of the present disclosure. For a better understanding of the disclosure, three different views of the sporting good 260 are shown, i.e. two lateral views (left and right illustration) and a view from below (middle illustration). In FIG. 2 it is shown that the component 240 is an outsole 290 of the sporting good 260. In some embodiments, the component 240, i.e. the outsole 290 of the shoe is manufactured according to the method 100 described with respect to FIG. 1.

Coming back to FIG. 2, in some embodiments, the liquefied polymer 230 is deposited following a continuous dispensing path onto the second component 250. In this manner, the outsole 290 can comprise a linear arrangement. In some embodiments, the liquefied polymer 230 is deposited onto a second component 250, which, in the embodiment shown in FIG. 2, is not directly connected to the shoe upper. In some embodiments, the second component 250, onto which the liquefied polymer 230 is deposited, is directly connected to the shoe upper. In some embodiments, the pattern as per FIG. 2 is obtained by using a thin nozzle during deposition of the liquefied polymer 230, which follows the path indicated by the black line. In this manner, the outsole 290 obtains the pattern 300 as can be seen in FIG. 2, wherein the white areas do not carry any liquefied polymer. Accordingly, the second component 250 is visible through the outsole 290.

In some embodiments, the outsole 290 can comprise a different material than the midsole. In some embodiments, the midsole and the outsole can comprise the same material and/or shape. In some embodiments, the midsole and the shoe upper are produced by the above-described method. In this manner, the sporting good 260 is produced by the methods according to present disclosure. In some embodiments, an outsole 290 according to embodiments of the present disclosure is connected to such a midsole, which is produced in a one-step-process together with the shoe upper. In this context, the deposition is carried out using 3D printing.

In some embodiments, the outsole 290 can comprise a pattern 300. As can be seen in FIG. 2, in some embodiments, the component 240 that has been deposited can comprise a linear pattern. In some embodiments, the sporting good 260 can be manufactured by using the above-described methods for producing the component 240 according to the present disclosure, which is arranged as such on the midsole 350 of the sporting good 260. In some embodiments, the outsole 290 is arranged in a toe section 10, mid-foot section and a heel section 20 of the sports shoe.

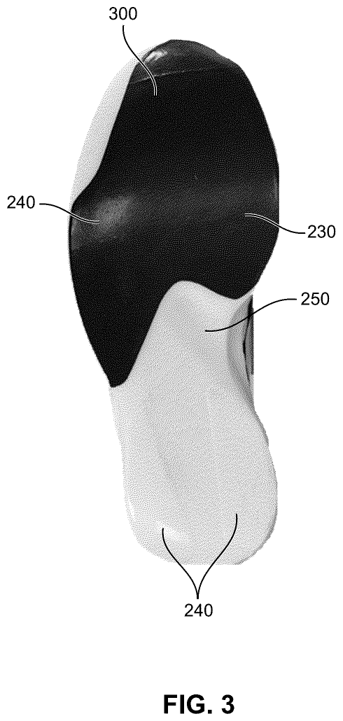

In FIG. 3 an embodiment of the outsole is shown. In some embodiments, the outsole 290 can comprise a pattern 300, which can be laminar. In some embodiments, the outsole 290 provides a glossy and shiny appearance. The outsole 290 in FIG. 3 can comprise two different colors, i.e. a dark colored in the mid- and fore-foot section, and light colored in the heel section. In some embodiments, the outsole 290 can comprise only one color, or more than two colors. In some embodiments, the outsole 290 is arranged in three segments, i.e. in one larger laminar segment positioned on the mid- and fore-foot section, and two smaller laminar segments positioned on the heel section.

To obtain this pattern or appearance, in some embodiments, the polymer is mixed with the solvent, and the liquefied polymer 230 is obtained, which is deposited on the second component 250, i.e. the midsole in a uniform manner.

In some embodiments, the liquefied polymer 230 is deposited onto one or more different sections of the sporting good 260, such as toe section, forefoot section, heel section, midsole section, sidewall section and/or the upper section. In some embodiments, the liquefied polymer is deposited by at least one of the following methods: brushing, coating, dipping, painting, automated dispensing, automated printing, or controlled dispensing. The deposition mode is carried out by an automated process. In some embodiments, the second component 250 is a midsole and/or a shoe upper or parts thereof, or both, and the second component may be manufactured by a 3D printing process. In some embodiments, 3D printing can comprise additive manufacturing methods, such as stereolithographic methods and laser sintering. With stereolithographic methods light causes chemical monomers and oligomers to cross-link together to form layer-wise polymers making up the 3D printed object. With laser sintering a laser causes powdered material to sinter due to heat. Aiming the laser at points in space defined by a 3D model, binding the material together creates a solid structure. Another example of an additive manufacturing method is fused deposition modeling in which the part is produced by extruding small beads or streams of material that harden immediately to form layers.

In some embodiments, in a subsequent step, the liquefied polymer 230, which is used to produce the outsole 290, is applied on the 3D printed midsole and/or shoe upper. In some embodiments, if both the midsole and the upper are manufactured using a 3D printing process, the midsole and the upper may be manufactured in separate 3D printing processes and connected afterwards, e.g. by gluing, welding sewing, etc. Alternatively, in some embodiments, the midsole and the upper may be manufactured together in a single manufacturing step.

In the embodiment of FIG. 3 the second component is a midsole made from a polymer material and the liquefied polymer is applied onto the midsole, thus forming the outsole 290. In some embodiments, the polymer material may be an Ethylene-vinyl acetate (EVA), a thermoplastic urethane (TPU) or a supercritical foam.

In FIG. 4 the outsole 290 can comprise a pattern 300, which is linear in some embodiments. To obtain this pattern, in some embodiments the liquefied polymer 230 is deposited in a continuous dispensing mode. In some embodiments, the linear pattern is characterized in that it can comprise lines or strips with a consistent width (for example, the width of the liquefied polymer 230 can vary by up to 5% relative to a target width as the liquefied polymer 230 is deposited), which is achieved by using a dispenser nozzle resulting in a consistent discharge during the deposition. In this manner, in some embodiments the liquefied polymer 230 is dispensed without interruption of the deposition process. In some embodiments, the liquefied polymer 230 can comprise unchanged physical properties during the whole deposition process. For example, physical properties such as hardness, color, elasticity, traction, etc., of the liquefied polymer 230 can remain unchanged if the liquefied polymer 230 is deposited under the same conditions (for example, the same nozzle size, deposition temperature, deposition pressure, etc.). In some embodiments, the outsole 290 is obtained according to the methods described with respect to FIG. 1. In some embodiments, the component 240 can comprise a thickness of 0.3 mm-0.7 mm, or 0.5 mm after curing.

In some embodiments, the second component is a midsole made from a polymer material and the liquefied polymer is applied onto the midsole, thus forming the outsole 290. In such embodiments, the polymer material may be an Ethylene-vinyl acetate (EVA), a thermoplastic urethane (TPU) or a supercritical foam.

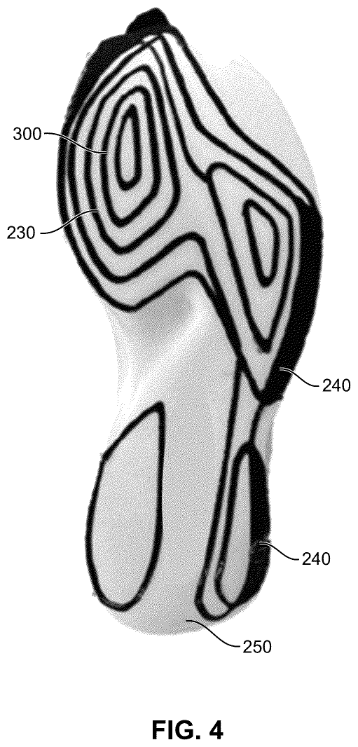

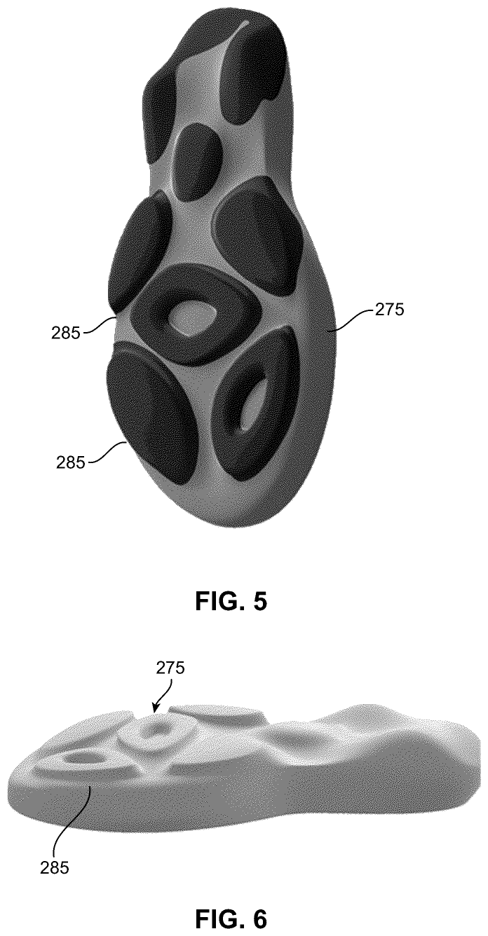

In FIGS. 5 and 6, the component 240, which is produced according to the methods of the present disclosure as described above, is used as a stud 285 for a sports shoe. In some embodiments, the sports shoe can be a football shoe 275. As can be seen in FIGS. 5 and 6, in some embodiments, the studs 285 are arranged on the sole of the football shoe 275. In some embodiments, the studs 285 can comprise a different shape and appearance than the sole of the football shoe 275. In some embodiments, the studs 285 and the sole of the football shoe 275 are produced in several individual steps, e.g. a separate production of the studs and the sole according to embodiments of the present disclosure and subsequent deposition of the studs 285 onto the sole. In some embodiments, the studs 285 are produced using different materials than the sole. In some embodiments, the material of the sole and the studs 285 of the football shoe 275 is the same, which can be seen in greater detail in FIG. 6. In some embodiments, the studs 285 and the sole in FIG. 6 are manufactured in a one-step-process according to the methods of present disclosure.

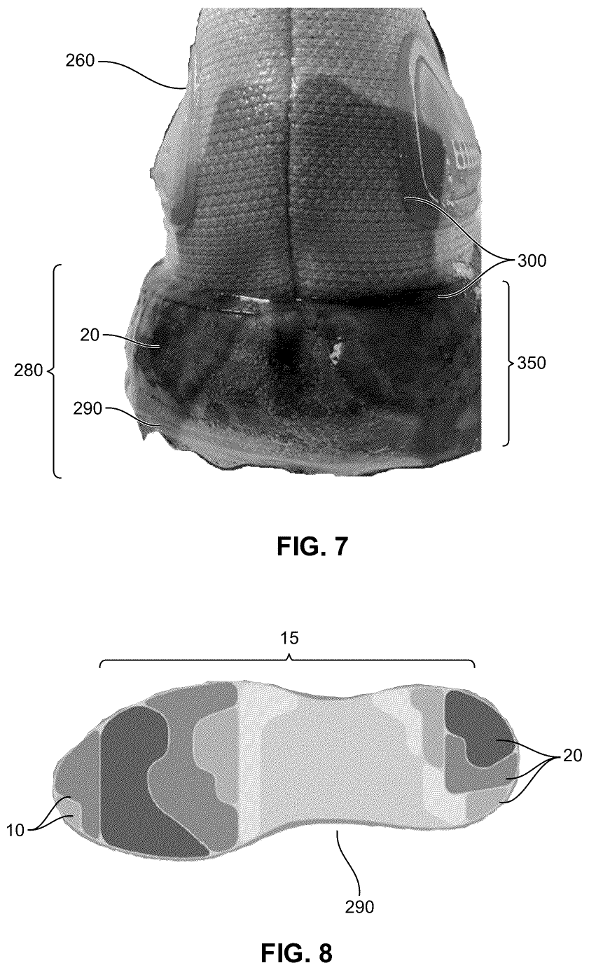

In some embodiments, the component 240 produced according to embodiments of the present disclosure is applied in transition zones of the sporting good 260, which can be seen in greater detail in FIG. 7. In some embodiments, the component 240 is applied in more than one portion of the sporting good 260. As can be seen in FIG. 7, in some embodiments, the sporting good 260 can comprise an outsole 290 and a midsole 350 wherein the component 240 is arranged on both of the shoe elements, i.e. on the sole 280, i.e. the midsole 350 and the outsole 290 as well as on the shoe upper of the sporting good 260. In some embodiments, to obtain this pattern, the liquefied polymer 230 is additionally deposited onto the midsole 350 and the shoe upper. In some embodiments, the midsole 350 and the outsole 290 can comprise the same shape and/or material. However, it is also possible that in some embodiments, the midsole 350 and the outsole 290 can comprise a different pattern and/or material. In some embodiments, the liquefied polymer 230 is textured after deposition. In some embodiments, the addition of textures to the deposited liquefied polymer 230 is performed using texturing devices such as a pattern brush and/or a pattern roller. In some embodiments, the addition of textures and structures is further performed though pressing pattern via pattern devices in the deposited semi-dried liquefied polymer 230. In some embodiments, the component 240 is deposited in the transition zone of the outsole 290 and in particular in the heel section 20 of the outsole 290. Using this approach, the component 240 may be arranged as such to create a pattern 300 on more than one portion of the sporting good 260.

As discussed in the outset of present disclosure, the liquefied component can be deposited on predetermined portions of the sporting good 260, using a torsion map, an abrasion map and/or a pressure map, which is illustrated in FIGS. 8 to 11. In this manner, the liquefied polymer 230 is applied to the areas where the most abrasion, traction or torsion is measured.

In FIG. 8, the predetermined zones of the sole 280 according to embodiments of the present disclosure are measured using an abrasion map, in some embodiments. In some embodiments, the abrasion map is used for determining the zones of an outsole 290 onto which the liquefied polymer is applied as described herein. In this manner, the liquefied polymer 230 is applied e.g. in sidewalls, toe section 10 and heel section 20. In some embodiments, the mid-foot section 15 can be left out with the liquefied polymer 230. In some embodiments, the liquefied polymer 230 is also applied on the mid-foot section 15. Using this approach, the liquefied polymer 230 can be applied with different physical properties, such as thickness weight, color, and/or viscosity on the predetermined zones. In some embodiments, each measured area with its special needs can be individually addressed during the deposition of the liquefied polymer 230 onto the second component 250 (e.g. a midsole, an upper or the like). In some embodiments, this approach can be used for example for enhancing the durability of a sporting good based on the different traction, abrasion and/or pressure that is applied thereon during its use. In some embodiments, the liquefied polymer 230 is deposited using a mask. In this way, the liquefied polymer 230 is deposited onto the sporting good in a desired zone and/or pattern.

In some embodiments, the abrasion, traction and/or pressure map varies based on the sporting good, and moreover, based on the sports type (e.g., basketball, football, tennis etc.) wherein the sporting good may be used. For example, the sole, and in some embodiments the outsole of a basketball shoe is enhanced by applying the component 240 in the one or more areas where the most lateral traction is recorded. Likewise, the component 240 is applied in the sidewall areas of the sole of a tennis shoe in some embodiments, in order to support these areas, which show the most traction and/or abrasion.

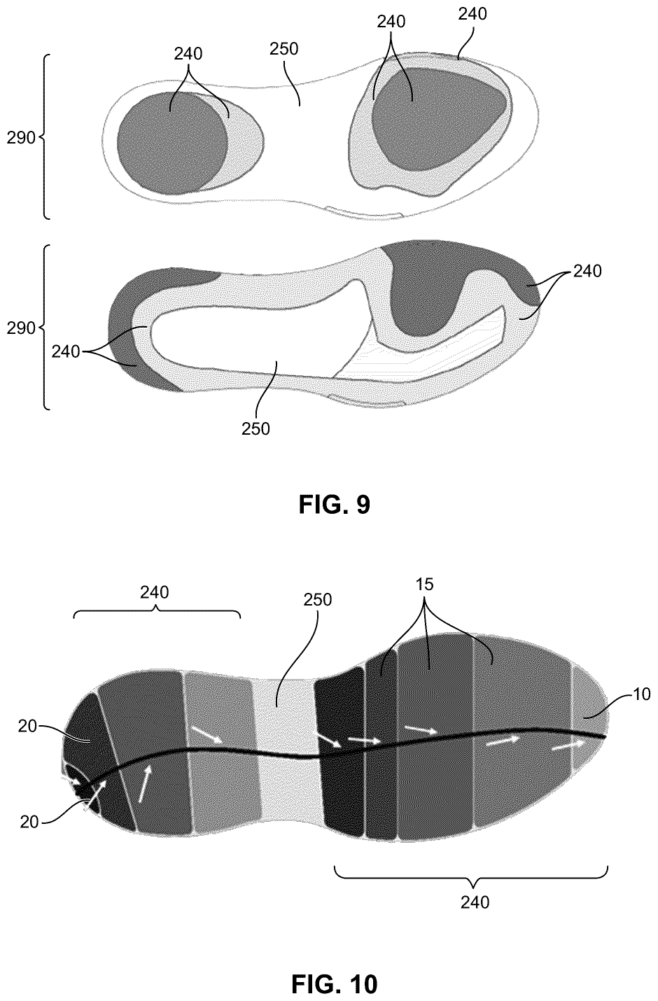

Coming now to FIG. 9, two maps are shown for the outsole 290 according to embodiments of the present disclosure comprising predetermined zones. In some embodiments, these predetermined zones are determined/measured using a traction map, abrasion map and/or pressure map. In the first map (upper), in some embodiments, the outsole 290 can comprise in particular thicker layers of component 240 in the “mid-foot to fore-foot” heel zone. In some embodiments, the thickness of the component 240 arranged at the rim compared to the component 240 arranged at the middle area may vary. In some embodiments, the neighboring areas that surround precisely these thicker areas, can also comprise the component 240 in layers with a different thickness. In some embodiments, the edging rims of both the thickest areas as well as the neighboring areas may further vary, i.e. can comprise the component 240 with a different thickness. In some embodiments, the remaining areas can comprise thinner layers or no layers of the component 240.

In the second map (bottom), in some embodiments, the outsole 290 can comprise thicker layers of the component 240 in the “heel-to-sidewall” zone as well as on the “mid-foot-to-sidewall” zone. Just as in the upper map, in some embodiments, the thickness on the rim and the middle area of the deposited component 240 may vary. In some embodiments, the neighboring areas that surround these thicker areas can also comprise the component 240 in layers with a different thickness. In some embodiments, the edging rims of both the “thickest” areas as well as the “neighboring” areas can further comprise the component 240 with a different thickness. In some embodiments, the remaining areas can comprise thinner layer or no layers of the component 240. As a result, in some embodiments, the component 240 reduces the overall weight of the outsole and of the sporting good while in the same time enhances the durability of the sporting good.

FIG. 10 shows a traction map for determining predetermined zones of an outsole 290 according to embodiments of the present disclosure. Using this approach, in some embodiments, the component 240 and in particular the liquefied polymer 230 is applied with different thickness and viscosity onto the second components 250 in different zones, e.g. the toe section 10, the mid-foot section 15 and/or the heel section 20. In some embodiments, these predetermined zones may vary from zones that may be measured by another map, for example a pressure map as shown in FIG. 11.

In FIG. 11 a pressure map is shown, which can be used for determining predetermined zones of an outsole 290 according to embodiments of the present disclosure. As can be seen in FIG. 11, in some embodiments, the heel section 20 shows increased pressure (the darker sections) as compared to the mid-foot section 15 (which comprises lighter sections that indicate decreased pressure). In some embodiments, this difference can be addressed by applying the component 240 in these “high-pressure” zones, i.e. depositing thicker layers of liquefied polymer onto these “high-pressure” areas.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents

What is claimed is:

1. A method for producing a component, such as a sporting good, comprising the following steps:
a. providing a polymer;
b. providing a solvent;
c. mixing the polymer with the solvent, thereby producing a liquefied polymer; and
d. curing the liquefied polymer, thereby producing the component.

2. The method according to claim 1, wherein the component is a first component of the sporting good, and the method further comprises the step of depositing the liquefied polymer obtained in the mixing step onto a second component of the sporting good, wherein the depositing step precedes the curing step.

3. The method according to claim 2, further comprising the step of texturing the liquefied polymer obtained in the mixing step, wherein the texturing step precedes the curing step.

4. The method according to claim 1, wherein the sporting good is a sports shoe.

5. The method according to claim 4, wherein the component is an outsole of the sports shoe.

6. The method according to claim 4, wherein the sports shoe is a football shoe.

7. The method according to claim 4, wherein the component is a stud of the sports shoe.

8. The method according to claim 4, wherein the liquefied component is deposited onto one or more sections of the sports shoe, the one or more sections comprising a toe section, a forefoot section, a heel section, a midsole section, a sidewall section, an upper section, or a combination thereof.

9. The method according to claim 2, wherein the liquefied component is deposited onto one or more predetermined portions of the sporting good.

10. The method according to claim 9, wherein the one or more predetermined portions of the sporting good is determined using a torsion map, an abrasion map, a pressure map, or a combination thereof.

11. The method according to claim 2, wherein the liquefied component is deposited onto the second component in a pattern.

12. The method according to claim 11, wherein the pattern comprises a laminar, a linear pattern, or a combination thereof.

13. The method according to claim 2, wherein the first component is deposited onto the second component with a thickness of 1-10 mm.

14. The method according to claim 2, wherein the thickness of the first component after the curing step is 0.3 mm-0.7 mm.

15. The method according to claim 2, wherein the depositing step is carried out by at least one of the following methods: brushing, coating, dipping, painting, automated dispensing, automated printing, or controlled dispensing.

16. The method according to claim 2, wherein the second component is produced via 3D printing, and wherein the second component is at least a portion of a mid-sole, at least a portion of a shoe upper or a combination thereof.

17. The method according to claim 2, wherein the liquefied polymer is deposited in a first section of the sporting good with a dynamic viscosity of 30000 to 50000 mPa·s; and the liquefied polymer is deposited in a second section of the sporting good with a dynamic viscosity of 10000 to 30000 mPa·s.

18. The method according to the claim 17, wherein the first section is an outer rim of the second section of the sporting good.

19. The method according to claim 2, wherein a contact angle θ between the liquefied polymer and the second component is 30° to 110°.

20. The method according to claim 1, wherein the curing step is carried out using radiation.
